(19) United States
(12) Patent Application Publication
(10) Pub. No.: US 2008/0111031 A1
(43) Pub. Date: May 15, 2008

(54) Deployable flat membrane structure

(75) Inventor: Mehran Mobrem, Santa Barbara, CA (US)

Correspondence Address: MILLER IP GROUP, PLC;NORTHROP GRUMMAN CORPORATION, 42690 WOODWARD AVENUE, SUITE 200, BLOOMFIELD HILLS, MI, 48304, US

(73) Assignee: Northrop Grumman Space & Missions Systems Corp., Los Angeles, CA (US)

(21) Appl. No.: 11/595,347

(22) Filed: Nov. 9, 2006

(51) Int. Cl. B64G 1/22; B64G 1/00; B64G 1/10

(52) U.S. Cl. 244/172.6; 244/159.5; 244/158.1

(57) ABSTRACT

A truss structure for supporting a membrane that is to be deployed in space, where the truss structure maintains the membrane sufficiently flat with uniform tension. The truss structure includes a circular perimeter truss and a transitional truss. The transitional truss includes a series of ties that are coupled to the perimeter truss and the membrane. When the truss structure is deployed, telescopic parts of the perimeter truss that are stowed in expansion cause the transitional truss to expand and pull the membrane into the flat configuration.

### BACKGROUND OF THE INVENTION

1. Field of the Invention

This invention relates generally to a deployable truss structure for a spacecraft and, more particularly, to a deployable truss structure for maintaining a membrane sufficiently flat in a space environment.

2. Discussion of the Related Art

Spacecrafts sometimes employ various types of devices, such as reflectors, antenna arrays, sensors, etc., that must be deployed from the spacecraft on a boom and associated truss when the spacecraft is on orbit or in space. These booms and trusses typically employ support rods coupled together by hinges that allow the boom and the truss to be folded or stowed in the spacecraft envelope or fairing during launch, and then be unfolded in space to the deployed position. Various devices and techniques are known in the art for unfolding or deploying a boom and truss, including the use of motors, preloaded springs and various types of actuators.

For certain spacecraft missions, there is a need to deploy a flat membrane on a truss at the end of a boom, such as a Fresnel lens that is part of a telescope, where the lens is a thin plastic sheet. It is necessary that the lens be folded in the fairing for launch, and then be deployed in space on the truss, where the truss maintains the lens in tension so as to keep it flat for effective operation. The truss must be stowed in a small volume, be lightweight and have a high bending and torsional stiffness. If the membrane does not have uniform tension, then some areas of the membrane will have greater tension than other areas of the membrane, possibly causing wrinkles that adversely affect the membrane's performance.

### SUMMARY OF THE INVENTION

In accordance with the teachings of the present invention, a truss structure for supporting a membrane is disclosed that is able to be deployed in space and maintain the membrane sufficiently flat with uniform tension. The truss structure includes a circular perimeter truss and a transitional truss. The transitional truss includes a series of ties that are coupled to the perimeter truss and the membrane. When the truss structure is deployed, telescoping parts of the perimeter truss that are stowed in expansion cause the transitional truss to expand and pull the membrane into the flat configuration.

Additional features of the present invention will become apparent from the following description and appended claims, taken in conjunction with the accompanying drawings.

### BRIEF DESCRIPTION OF THE DRAWINGS

FIG. 1 is a perspective plan view of a satellite launch faring including a stowed truss structure and a telescopic boom;

FIG. 2 is a perspective view of a spacecraft and a deployed truss structure, according to an embodiment of the present invention, that maintains a membrane in a flat configuration;

FIG. 3 is a perspective view of the deployed truss structure separated from the spacecraft;

FIG. 4 is a front view of the deployed truss structure separated from the spacecraft; and

FIG. 5 is a side view of the perimeter truss structure of the invention in a partially deployed configuration.

### DETAILED DESCRIPTION OF THE EMBODIMENTS

The following discussion of the embodiments of the invention directed to a truss structure for deploying a membrane in a flat configuration under uniform tension is merely exemplary in nature, and is in no way intended to limit the invention or its applications or uses.

FIG. 1 is a perspective plan view of a space launch vehicle 10 including a fairing envelope 12. The fairing envelope 12 encloses a spacecraft body 14, a telescopic boom 16 and a truss structure 18, where the telescopic boom 16 and the truss structure 18 are in a stowed configuration for launch. When the vehicle 10 is launched into space, the fairing envelope 12 is ejected, and the spacecraft body 14 becomes operational. The telescopic boom 16 is then deployed, and the truss structure 18 is deployed thereafter.

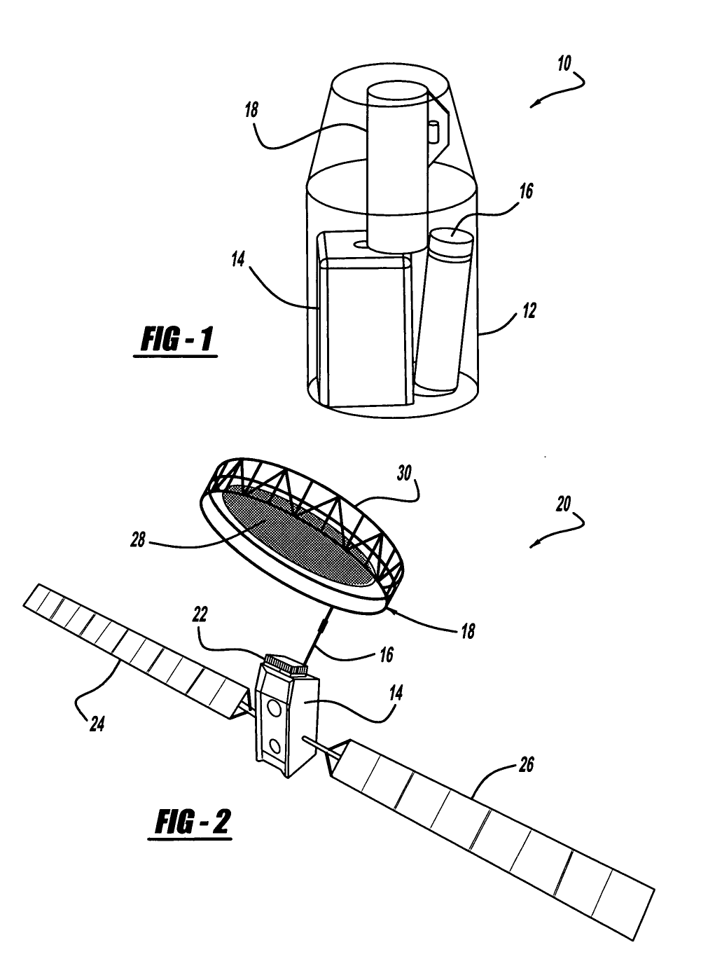

FIG. 2 is a perspective view of a spacecraft 20 including the spacecraft body 14. Two solar arrays 24 and 26, the boom 16 and the truss structure 18 are mounted to the spacecraft body 14 and have been extended or deployed. A Fresnel lens 28 is mounted to the truss structure 18, where the Fresnel lens 28 is a thin plastic membrane and would be part of a telescope 22 on the spacecraft body 14. The deployment of telescopic booms and truss structures for a spacecraft on orbit is a process that is well understood to those skilled in the art.

As will be discussed in detail below, the truss structure 18 has a configuration that when deployed spreads the lens 28 in a flat configuration having uniform tension, according to the invention. The Fresnel lens 28 is provided by way of a non-limiting example in that the truss structure 18 of the invention has application for supporting any type of membrane in a flat configuration with uniform tension.

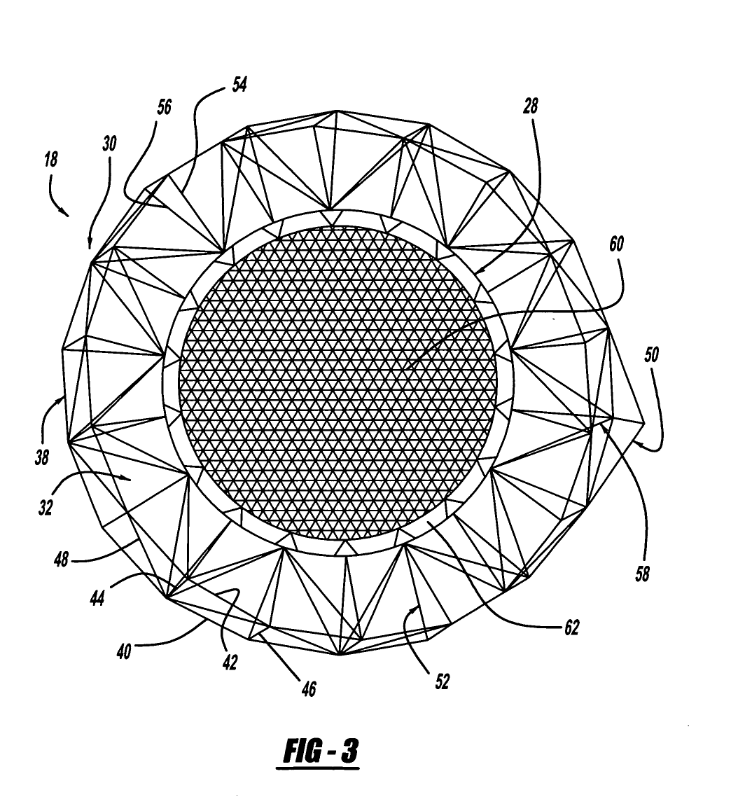

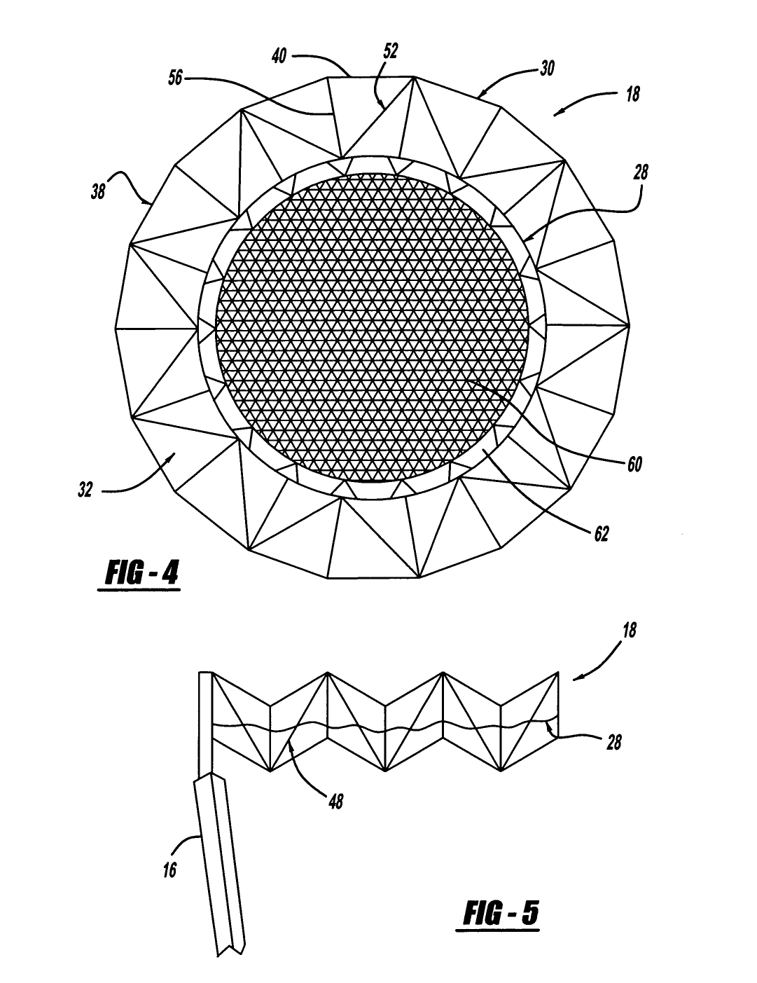

FIG. 3 is a perspective view and FIG. 4 is a front view of the truss structure 18 separated from the spacecraft body 14 and the boom 16. The truss structure 18 includes a perimeter truss 30 and a transitional truss 32. The perimeter truss 30 includes a plurality of interconnected perimeter truss sections 38, where each section 38 includes a pair of parallel longerons 40 and 42, and a pair of parallel battens 44 and 46 that are perpendicular to the longerons 40 and 42 and are coupled thereto. A telescopic diagonal 48 is coupled to diagonal corners of each section 38. Each adjacent truss section 38 shares a common batten 44 or 46, where the combination of the truss sections 38 define a circle. The longerons 40 and 42 and the battens 44 and 46 would each have a length to define the circular configuration of the perimeter truss 30, be lightweight and have the proper rigidity and stiffness for the purposes discussed herein. It is noted that the perimeter truss 30 can have other configurations within the scope of the present invention.

The transitional truss 32 includes a plurality of transitional truss sections 52, each including a pair of ties 54 and 56. One end of each tie 54 and 56 is coupled to a common location of the lens 28, and the other end of each tie 54 and 56 is coupled to opposing ends of a batten 44 or 46. Some of the transitional truss sections 52 are angled and some are straight, where every one of either the batten 44 or 46 includes three transitional truss sections 52 coupled to it and every other of the batten 44 or 46 includes a single transitional truss 52 coupled to it in an alternating sequence, as shown. A prime batten 58 including a truss 50 couple the telescopic boom 16 to the perimeter truss 30 with the appropriate rigidity and pointing stiffness. It is noted that the transitional truss 32 can have other configurations within the scope of the present invention.

The lens 28 includes an inner membrane 60 and a perimeter catenary 62. The membrane 60 is made of a suitable plastic, such as Kapton, for the Fresnel lens 28, and has a desired thickness. The catenary 62 provides a transitional region between the membrane 60 and the ties 54 and 56 to provide a robust enough structure for supporting the membrane 60 with uniform tension in a flat configuration. In this configuration, the lens 28 is positioned at a central location of the truss structure 18 in that it aligns midway along the length of the battens 44 and 46 as provided by the ties 54 and 56.

The structural components of the truss structure 18 can be made of any suitable material for the purposes described herein. In one non-limiting embodiment, the longerons 40 and 42, the battens 44 and 46 and the diagonals 48 are made of a graphite composite and have a tubular shape. The ties 54 and 56 are foldable members and can be tapes or cables that provide tension, but not compression. Suitable materials for the ties 54 and 56 include graphite, Kevlar and fiberglass. The longerons 40 and 42, the battens 44 and 46, the diagonals 48 and the ties 54 and 56 are coupled together in the configuration as shown using any suitable coupling device, such as metal or graphite fittings, glue, etc, which would be well understood to those skilled in the art. When the truss structure 18 is deployed, as shown, the lens 28 and the transitional truss 32 will be in tension, and the perimeter truss 30 will be in compression. In order to provide such a compression, the longerons 40 and 42, the battens 44 and 46 and the diagonals 48 must be relatively stiff.

In one non-limiting embodiment, the lens 28 has a diameter of about two meters and a thickness of about 0.001 inches. The perimeter truss 30 has a diameter of about three meters and the telescopic boom 16 has a deployed length of about eight meters. In another embodiment, the lens 28 has a diameter of about three meters, the perimeter truss 32 has a diameter of about four meters and the telescopic boom 16 has a deployed length of about sixteen meters. Further, the satellite body 14 has a width of about twenty-four inches, a height of about twenty-four inches and a length of about forty inches. It is noted, however, that there is no limit for the diameter of the perimeter truss 30, and can be as large as it needs to be, such as 10, 20 or 50 meters.

The truss structure 18 is compressed or folded into a cylinder when it is in the stowed configuration. A strap (not shown) is wrapped around the outside of the perimeter truss 30 to hold it in the stowed configuration. Once the spacecraft body 12 is on orbit, and the lens 28 is to be deployed, the boom 16 is first extended from the spacecraft body 12 in a manner that is well understood in the art. The strap is then released by a suitable device (not shown). The diagonals 48 are telescopic members that are stowed in expansion, where they may have static energy. When the strap is released, the static energy stored in the diagonals 48 is released causing the diagonals 48 to reduce in length, which causes the perimeter truss 30 to expand and open, pulling the transitional truss 32 and the lens 28 into tension and providing the configuration shown in FIGS. 3 and 4. In an alternate embodiment, a motorized cable driven system can deploy the truss structure 18 by pulling a cable that goes through the middle of the diagonals 48 causing the reduction of their length. FIG. 5 is a side view of the truss structure 18 in a partially deployed configuration where the diagonals 48 are longer than they are shown in FIGS. 3 and 4.

The foregoing discussion discloses and describes merely exemplary embodiments of the present invention. One skilled in the art will readily recognize from such discussion, and from the accompanying drawings and claims, that various changes, modifications and variations can be made therein without departing from the spirit and scope of the invention as defined in the following claims.

What is claimed is:

1. A truss structure for a spacecraft, said structure comprising:
a perimeter truss including a plurality of interconnected perimeter truss sections, each perimeter truss section including first and second parallel longerons, first and second parallel battens coupled to ends of the first and second longerons, and a diagonal coupled to diagonally opposed connections between a longeron and a batten, wherein adjacent perimeter truss sections share a single batten;
a transitional truss including a plurality of transitional truss sections, each transitional truss section including first and second ties, where one end of the ties in each transitional truss section are coupled together and opposing ends of the ties for each section are coupled to opposite ends of a batten, said plurality of transitional truss sections being configured so that three transitional truss sections are coupled to every other batten and a single transitional truss section is coupled to the other battens in an alternating sequence; and
a membrane coupled to the coupled ends of the ties so that the membrane is spread out within the transitional truss, wherein the transitional truss is in tension so as to cause the membrane to have uniform tension in a planar configuration.

2. The structure according to claim 1 wherein the longerons, the battens and the diagonals are graphite tubes and the ties are foldable members selected from the group consisting of tapes and cables that provide tension, but not compression, and are made from a material selected from the group consisting of graphite, Kevlar and fiberglass.

3. The structure according to claim 1 wherein the membrane includes an inner membrane portion and an outer catenary portion, where the catenary portion is coupled to the ties.

4. The structure according to claim 1 where the membrane is a lens.

5. The structure according to claim 4 wherein the lens is a Fresnel lens.

6. The structure according to claim 1 wherein the membrane is centered within the transitional truss relative to the length of the battens.

7. The structure according to claim 1 wherein the truss structure is deployable from a folded cylindrical configuration, said diagonals being telescopic diagonals that cause the truss structure to be deployed by reducing their length.

8. The structure according to claim 1 wherein the perimeter truss and the transitional truss have a circular configuration.

9. A truss structure comprising:
a perimeter truss including a plurality of support members configured in a circular orientation;
a transitional truss including a plurality of support members coupled to the perimeter truss; and
a circular membrane positioned within the transitional truss and being coupled thereto, wherein the perimeter truss is in compression and the transitional truss is in tension so as to spread the membrane into a flat configuration having uniform tension that prevents membrane wrinkles.

10. The truss structure according to claim 9 wherein the perimeter truss includes a plurality of interconnected perimeter truss sections, each perimeter truss section including a plurality of the support members having first and second parallel longerons, first and second parallel battens coupled to ends of the first and second longerons, and a diagonal coupled to diagonally opposed interconnections between a longeron and a batten, wherein adjacent perimeter truss sections share a single batten.

11. The truss structure according to claim 9 wherein the transitional truss includes a plurality of transitional truss sections, each transitional truss section including a plurality of the support members having first and second ties, where one end of the ties in each section is coupled together and opposing ends of the ties for each section are coupled to the perimeter truss.

12. The truss structure according to claim 9 where the membrane is a lens.

13. The truss structure according to claim 12 wherein the lens is a Fresnel lens.

14. The truss structure according to claim 9 wherein the membrane is centered within the transitional truss relative to a width of the perimeter truss.

15. The truss structure according to claim 9 wherein the truss structure is deployable from a folded cylindrical configuration, wherein some of the perimeter truss support members are telescopic rods that cause the truss structure to be deployed by reducing their length.

16. The structure according to claim 9 wherein the perimeter truss support members are graphite tubes.

17. The structure according to claim 9 wherein the transitional truss support members are foldable members selected from the group consisting of tapes and cables that provide tension, but not compression, and are made from a material selected from the group consisting of graphite, Kevlar and fiberglass.

18. A truss structure for supporting a membrane where the truss structure is coupled to a telescopic boom and the telescopic boom is coupled to a spacecraft body, said truss structure comprising:
a perimeter truss including a plurality of support members configured in a circular orientation; and
a transitional truss including a plurality of support members coupled together to provide triangular configurations where the tip of the triangle is opposite to the perimeter truss, said membrane being coupled to the tips of the triangular sections of the transitional truss so that the membrane is centered relative to a width of the perimeter truss.

19. The truss structure according to claim 18 wherein the transitional truss includes a plurality of transitional truss sections, each transitional truss section including a plurality of the support members having first and second ties, where one end of the ties in each section is coupled together and opposing ends of the ties for each section are coupled to the perimeter truss.

20. The truss structure according to claim 18 wherein the perimeter truss includes a plurality of interconnected perimeter truss sections, each perimeter truss section including a plurality of the support members having first and second parallel longerons, first and second parallel battens coupled to ends of the first and second longerons, and a diagonal coupled to diagonally opposed interconnections between a longeron and a batten, wherein adjacent perimeter truss sections share a single batten.
